(19) United States
(12) Patent Application Publication
(10) Pub. No.: US 2006/0232954 A1
(43) Pub. Date: Oct. 19, 2006

(54) Lamp structure with a signal transmission alert

(75) Inventor: Kevin Lee, Taipei (TW)

Correspondence Address: Lipan Industrial Co., Ltd., P. O. Box No. 6-57, Junghe, Taipei, 235, TW

(73) Assignee: Lipan Industrial Co., Ltd., Taipei (TW)

(21) Appl. No.: 11/108,801

(22) Filed: Apr. 19, 2005

(51) Int. Cl. F21V 33/00

(52) U.S. Cl. 362/101

(57) ABSTRACT

A lamp structure with a signal transmission alert includes a lamp seat and a transparent shade, wherein a concave space is located at a bottom of the lamp seat within which located a light and heat source. The light and heat source is connected to a personal computer via a USB signal line. A liquid containing transparent or reflective floating objects or other dynamic devices with changeable colors is filled in the transparent shade. The transparent shade is connected to the concave space in the lamp seat. The light and heat source can be driven with a power provided from the USB device to generate a heat during transmitting computer data, so as to form convection in the liquid in the transparent shade. The floating objects constituting a visual effect of exotic, dynamic, and versatile style is able to transmit along with the transmission of computer data.

### BACKGROUND OF THE INVENTION

1. Field of the Invention

The present invention relates to a lamp structure with a signal transmission alert, and more particularly to a lamp structure wherein a drifting effect can be created to floating objects or other dynamic devices with changeable colors in a sealed transparent container along with a transmission of computer data.

2. Description of the Prior Art

As the popularity of a personal computer in nowadays, all kinds of computer periphery products with sound and light effects, such as loudspeakers of all kinds of appearances, and computers which can generate light of different colors, were constantly developed to match a life habit of pursuing excitement and new stuffs. All these products can be used to increase the interest in using a personal computer by a consumer.

However, the aforementioned appearances or light effects only monotonically continue without any change, which is extremely easy to enable a consumer to lose interest. Therefore, how to increase interest in application for a consumer with a light vibration or sparkling with more variation and interest has become an issue to be solved by related industries.

### SUMMARY OF THE INVENTION

The primary object of the present invention is to provide a lamp structure with a signal transmission alert, which comprises primarily a transparent shade in which filled a liquid. And a plurality of transparent and reflective floating objects or other dynamic devices with changeable colors is dispersed in the liquid. A lamp seat containing a light and heat source, which is connected with a personal computer via a signal line, is combined with the transparent shade. The light and heat source is driven by the personal computer to generate a heat, which creates a convection effect to the liquid in the transparent shade along with a transmission of computer data. The floating objects or dynamic devices dispersed in the liquid in the transparent shade also display an effect of dynamic reflection or variation of light, thereby increasing a fun in using a computer.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an assembly view of the present invention.

FIG. 2 shows a schematic view of the present invention.

FIG. 3 shows a schematic view of a first implementation of a transparent shade of the present invention.

FIG. 4 shows a schematic view of a second implementation of a transparent shade of the present invention.

FIG. 5 shows a schematic view of a third implementation of a transparent shade of the present invention.

FIG. 6 shows a schematic view of a fourth implementation of a transparent shade of the present invention.

FIG. 7 shows a schematic view of a fifth implementation of a transparent shade of the present invention.

### DETAILED DESCRIPTION OF THE PREFERRED EMBODIMENTS

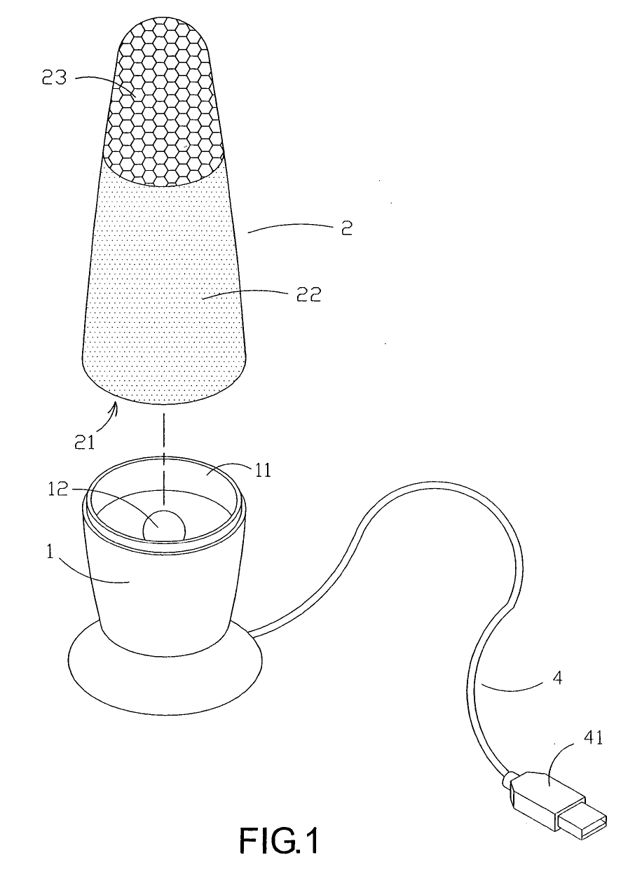

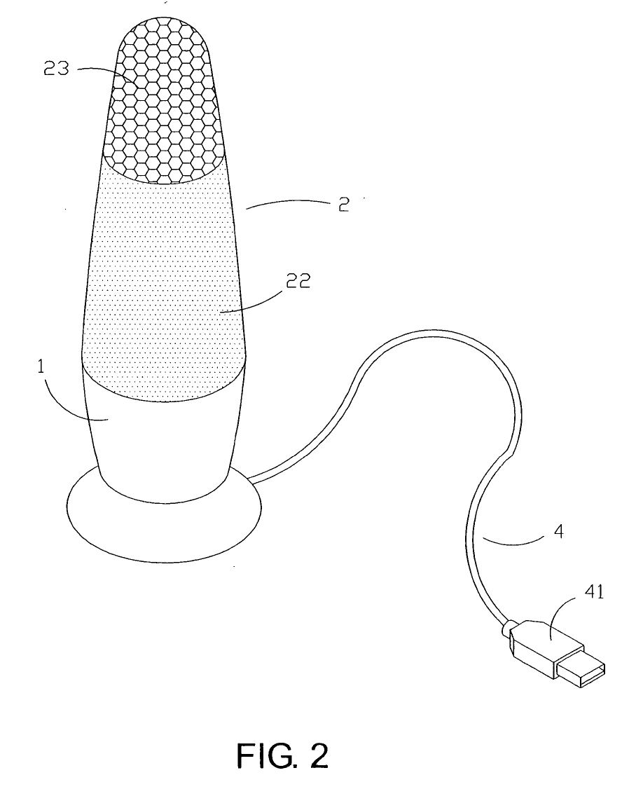

Referring to FIG. 1 and FIG. 2, the present invention comprises primarily a lamp seat 1, a transparent shade 2, and a signal line 4, wherein a concave space 11 is at a top side of the lamp seat 1, and a light and heat source 12 is located in the concave space 11. The light and heat source 12 is connected to a default personal computer with a plug 41 (can be in a USB specification) via the signal line 4. A decoration shade 23 and a concave part 21 are located at a bottom and a top side of the transparent shade 2, respectively. Inside the transparent shade 2 is a sealed space which contains a transparent liquid 22.

The transparent shade 2 is latched on the concave space 11 of the lamp seat 1 upon assembling, so as to locate the light and heat source 12 just below the concave part 21 of the transparent shade 2. When the signal line 4, which is connected with the light and heat source 12, connects to a personal computer with the plug 41, or the computer is receiving external data (such as receiving an E-mail, downloading or copying data) or uploading data, the light and heat source 12 can be driven via the signal line 4 to emit and project a light into the transparent shade 2, and to generate a heat to heat up the liquid 22 in the transparent shade 2 for starting a convection to the liquid 22 in the transparent shade 2.

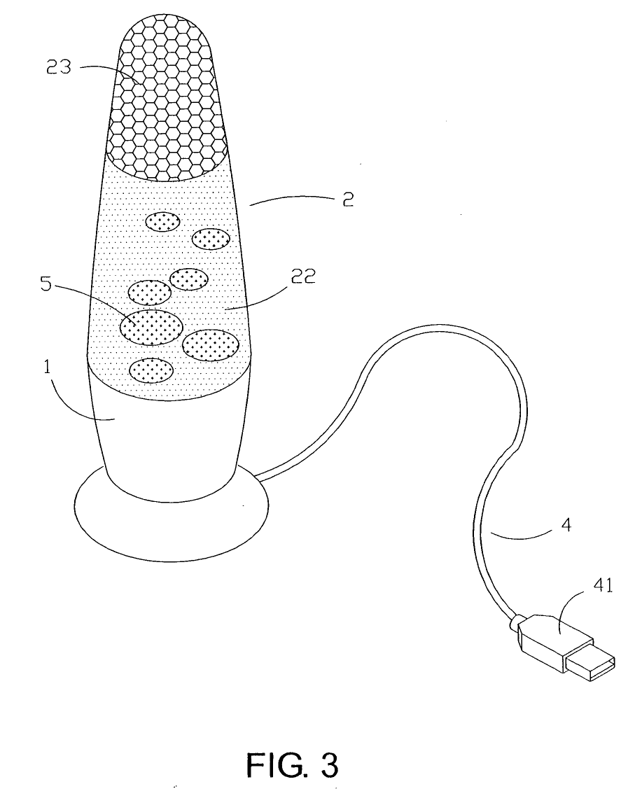

Referring to FIG. 3, it shows a schematic view of a first implementation of a transparent shade. Floating waxes 5 are contained in the liquid 22 in the transparent shade 2. By using a heat generated from the enlightening of the light source 12, convection is created to the liquid 22 in the transparent shade 2, and the waxes 5 are also floating accordingly, so as to display a dynamic effect of transparency, and form a visual effect of gently floating transparent objects in the transparent shade 2.

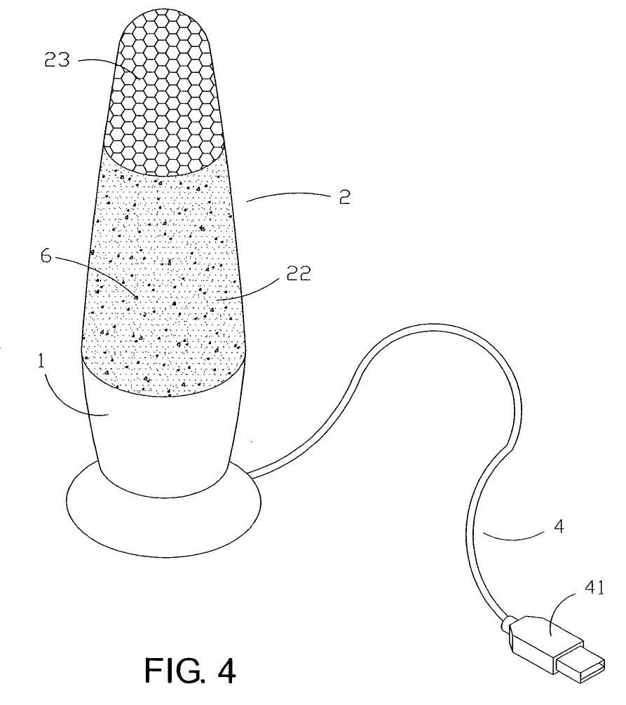

Referring to FIG. 4, it shows a schematic view of a second implementation of a transparent shade. A plurality of reflective spangles 6 is dispersed in the liquid 22 in the transparent shade 2. By using a heat generated from the enlightening of the light source 12, convection is created to the liquid 22 in the transparent shade 2, and the reflective spangles 6 are also floating accordingly, so as to display a dynamic effect of reflection, and form a visual effect of sparkling light dots in the transparent shade 2.

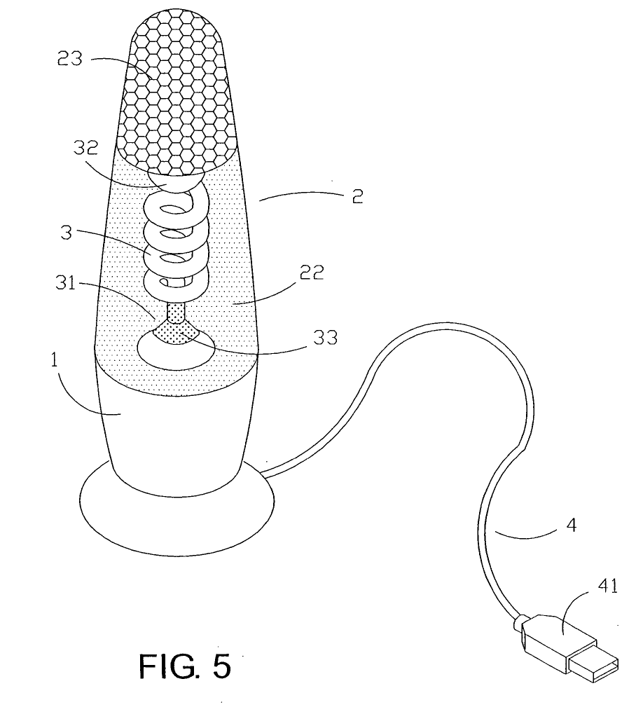

Referring to FIG. 5, it shows a schematic view of a third implementation of a transparent shade. A vertical transparent spiral tube 3 is located in the transparent shade 2 with a lower container 31 and an upper container 32 at a bottom and a top side of the spiral tube 3. A proper amount of colored liquid 33 is contained in the lower container 31 which is just located at a top of the light source 12 after assembling. By using a heat generated from the enlightening of the light source 12 to heat up the lower container 31, the colored liquid 33 in the lower container 31 is swollen and glided upward to the upper container 32 along the transparent spiral tube 3. After turning off the light source 12 and cooling off, the colored liquid 33 can be glided down spirally to the lower container 31 from the upper container 32, thereby forming a visually changing effect of spirally rotating.

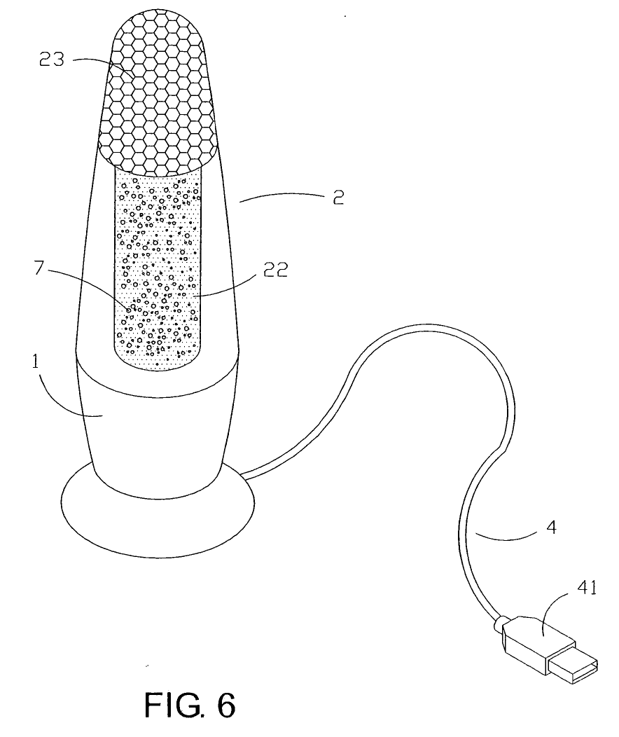

Referring to FIG. 6, it shows a schematic view of a fourth implementation of a transparent shade. A bubbling device is located at a bottom of the transparent shade 2 for sucking outside air into the transparent shade 2. Therefore, the liquid 22 in the transparent shade 2 is filled with bubbles 7, and another visual effect of sparkling light dots can be formed in the transparent shade 2 using a reflection and refraction effect of the bubbles 7 themselves.

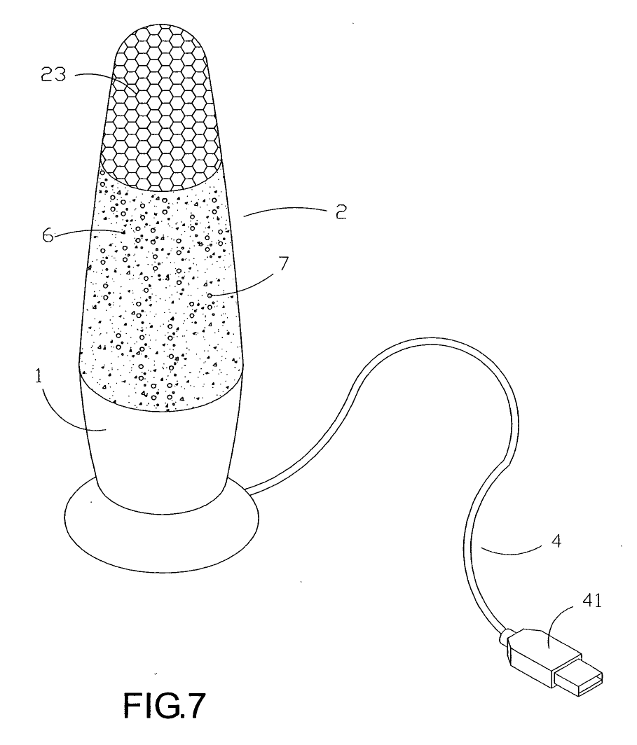

Referring to FIG. 7, it shows a schematic view of a fifth implementation of a transparent shade. In addition to install a bubbling device at a bottom of the transparent shade 2 for sucking outside air into the transparent shade 2 so as to fill bubbles 7 into the transparent shade 2, a plurality of floating reflective spangles 6 is dispersed in the transparent shade 2 and is drifting with a flow of the bubbles 7, in order to form a visual effect of varying sparkling light dots in the transparent shade 2 using a different reflection and refraction effect between the bubbles 7 and the reflective spangles 6.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A lamp structure with a signal transmission alert including at least a lamp seat whose top side is located a concave space within which installed a light and heat source connected to a default personal computer via a signal line; a transparent shade whose bottom side is located a concave part, with a liquid contained in the transparent shade; a light and heat generated by a light and heat source which is powered on along with a transmission of computer data, enabling convection in the liquid in the transparent shade due to heat up.

2. The lamp structure with a signal transmission alert according to claim 1, wherein a plurality of floating and transparent waxes and reflective spangles is contained in the liquid of the transparent shade.

3. The lamp structure with a signal transmission alert according to claim 1, wherein a vertical transparent spiral tube is located in the transparent shade, with a lower and an upper container located at a bottom and a top of the transparent spiral tube, respectively, and a proper amount of colored liquid is contained in the lower container.

4. The lamp structure with a signal transmission alert according to claim 1, wherein a bubbling device is located at a bottom of the transparent shade for sucking an outside air into the transparent shade, thereby filling bubbles into the liquid in the transparent shade.
